(19) United States
(12) Patent Application Publication
(10) Pub. No.: US 2015/0324008 A1
(43) Pub. Date: Nov. 12, 2015

(54) DISPLAY APPARATUS AND CONTROLLING METHOD THEREOF

(71) Applicant: LG ELECTRONICS INC., Seoul (KR)

(72) Inventor: Simdong YEO, Seoul (KR)

(21) Appl. No.: 14/340,327

(22) Filed: Jul. 24, 2014

(30) Foreign Application Priority Data
May 7, 2014 (KR) 10-2014-0054464

(51) Int. Cl. G06F 3/02; H05B 37/02; F21V 33/00

(52) U.S. Cl. CPC G06F 3/0202; F21V 33/0052; H05B 37/0218; F21Y 2101/02

(57) ABSTRACT

A display apparatus and a control method thereof are provided. The display apparatus includes a user manipulation unit on which a keypad is mounted, a display unit controlled by manipulating the keypad, and a lighting unit movably mounted on the display unit, the lighting unit emitting light to the outside of the display unit.

### CROSS-REFERENCE TO RELATED APPLICATIONS

The present application claims the benefit of priority to Korean Patent Application No. 10-2014-0054464, filed on May 7, 2014, which is hereby expressly incorporated by reference in its entirety.

### BACKGROUND

The present disclosure relates to a display apparatus and a control method thereof.

Display apparatuses represent apparatuses for expressing electrical information as visual information by displaying an image to a user. That is, display apparatuses may represent apparatuses including a display unit, such as televisions, desktop PCs, laptop PCs, and the like. In recent years, as display apparatuses such as smart phones, tablet PCs, or smart televisions are propagated rapidly, user interfaces (UI) or user experiences (UX) on the basis of user's preferences are being incorporated as important elements.

Such a display apparatus may include a user manipulation unit such as a keyboard or, in some cases, a remote controller. Thus, the display apparatus may be controlled by user's manipulation through the user manipulation unit. When the display apparatus including the user manipulation unit is manipulated by a user in a state where lighting does not exist, for example, when the user uses the user manipulation unit such as a keyboard of a laptop PC in a state where lighting is not provided, the display apparatus may further include a lighting unit for providing lighting in a direction of the user manipulation unit to improve a user's convenience in operating the manipulation unit.

A display apparatus including a lighting unit is disclosed in Korean Patent Application No. 10-2001-7016318. The display apparatus according to the related art includes a user manipulation unit including a keypad, a display unit that is rotatably hinge-coupled to the user manipulation unit and including a display and a lighting unit fixedly mounted on an upper or lower portion of a front surface of the display unit to provide light onto the keypad.

However, in the display apparatus according to the related art, as the lighting unit is fixed to the display unit, the light provided onto the keypad may be non-uniformly provided or move away from the direction of the keypad according to a rotation angle of the display unit.

Also, since separate switching manipulation for operating the lighting unit is needed, user's inconvenience is increased.

Thus, there is a need for solving the above-described limitations, reflecting the user's needs, and expanding user's experience.

### SUMMARY

Embodiments provide a display apparatus and a control method thereof.

In one embodiment, a display apparatus includes: a user manipulation unit on which a keypad is mounted; a display unit controlled by manipulating the keypad; and a lighting unit movably mounted on the display unit, the lighting unit emitting light to the outside of the display unit.

The display apparatus may further include a control unit provided in at least one of the user manipulation unit and the display unit to control an operation of the lighting unit.

The lighting unit may further include a camera module for photographing, and the control unit may control an operation of the lighting unit to allow the lighting unit to provide illumination for the photographing.

The display unit may be rotatably hinge-coupled to the user manipulation unit, the display apparatus may further include an angle detection part for detecting a rotation angle of the display unit, and the control unit may control an operation of the lighting unit on the basis of the result detected by the angle detection part.

The display apparatus may further include a light intensity detection part for detecting an intensity of the light, wherein the control unit may control the intensity of the light emitted from the lighting unit on the basis of the result detected by the light intensity detection part.

The control unit may turn the lighting unit on when the detected light intensity is less than preset light intensity and turn the lighting unit off when the detected light intensity is greater than the preset light intensity on the basis of the result detected by the light intensity detection part.

The display apparatus may further include a movement detection part for detecting movement on the user manipulation unit, wherein the control unit may turn the lighting unit on when the movement is detected and turn the lighting unit off when the movement satisfies a preset unused condition.

The display apparatus may further include a storage unit in which control information is stored, wherein the control unit may control an operation of the lighting unit according to the control unit information that is previously stored in the storage unit.

The preset control information may include at least one of mode information with respect to a power mode in which the lighting unit is turned on/off, a light intensity adjustment mode in which the intensity of the light is adjusted, a keypad mode in which the light is emitted toward a keypad, a short distance mode in which the light is emitted to a side that is close to the display unit, a long distance mode in which the light is emitted to a side that is away from the display unit, a lighting mode in which the light for simple illumination is emitted, a photographing mode in which the light for illumination when being photographed is emitted, and a video chatting mode in which the light for photographing a user is emitted when video chatting is performed.

The display apparatus may further include a distance detection part for detecting a distance between the display unit and the user manipulation unit, wherein the control unit may control an operation of the lighting unit on the basis of the result detected by the distance detection part.

The control unit may control movement of the lighting unit so that the light emitted from the lighting unit is distributed into a center of the keypad of the user manipulation unit.

The lighting unit may be mounted on the display unit to perform at least one movement of vertically rotating movement and horizontally linear movement at a front side of the display unit.

The lighting unit may include: a light source module generating the light; a lighting unit body on which on the light source module is mounted on a front surface thereof, the lighting unit body being mounted within the display unit so that the front surface of the light source module protrudes from the display unit; and a driving motor mounted within the display unit to vertically rotate the lighting unit body.

The lighting unit may further include a sliding plate that is mounted slidable in left and right directions within the display unit, and the lighting unit body and the driving motor may be mounted on the sliding plate, and a main body opening for exposing the front surface of the lighting unit body to the outside of the display unit is defined in one side of the sliding plate.

A guide opening for a portion of a front surface of the sliding plate may be defined in the display unit.

The lighting unit may be mounted on an upper or lower bezel of a front surface of the display unit.

The display apparatus may include one of a television, a desktop PC, and a laptop PC.

In another embodiment, a method of controlling a display apparatus including a lighting unit that is movably mounted on a display unit includes: detecting an angle between the display unit and a user manipulation unit on which a keypad is mounted; selecting a preset angle between the display unit and the lighting unit, which corresponds to the detected angle; and moving the lighting unit to a position corresponding to the selected angle.

The selected angle may be an angle at which light emitted from the lighting unit is distributed into a center of the keypad of the user manipulation unit.

In further another embodiment, a method of controlling a display apparatus including a lighting unit that is movably mounted on a display unit includes: executing a user mode; selecting preset control information in the user mode; and controlling an operation of the lighting unit according to the selected control information.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view illustrating a display apparatus according to an embodiment;

FIGS. 2 and 3 are views illustrating a lighting unit of the display apparatus of FIG. 1;

FIG. 4 is a view illustrating a lighting unit according to another embodiment;

FIG. 5 is a block diagram of the display apparatus of FIG. 1;

FIGS. 6 to 9 are views illustrating various control operations of the display apparatus of FIG. 1;

FIGS. 10 to 13 are flowcharts illustrating control methods of the display apparatus of FIG. 1;

FIG. 14 is a perspective view illustrating a display apparatus according to another embodiment;

FIG. 15 is a block diagram of the display apparatus of FIG. 14; and

FIG. 16 is a perspective view illustrating a display apparatus according to another embodiment.

### DETAILED DESCRIPTION OF THE EMBODIMENTS

Exemplary embodiments of the present disclosure will be described below in more detail with reference to the accompanying drawings. The description of the present disclosure is intended to be illustrative, and those with ordinary skill in the technical field of the present disclosure pertains will be understood that the present disclosure can be carried out in other specific forms without changing the technical idea or essential features. Also, for helping understanding of the invention, the drawings are not to actual scale, but are partially exaggerated in size.

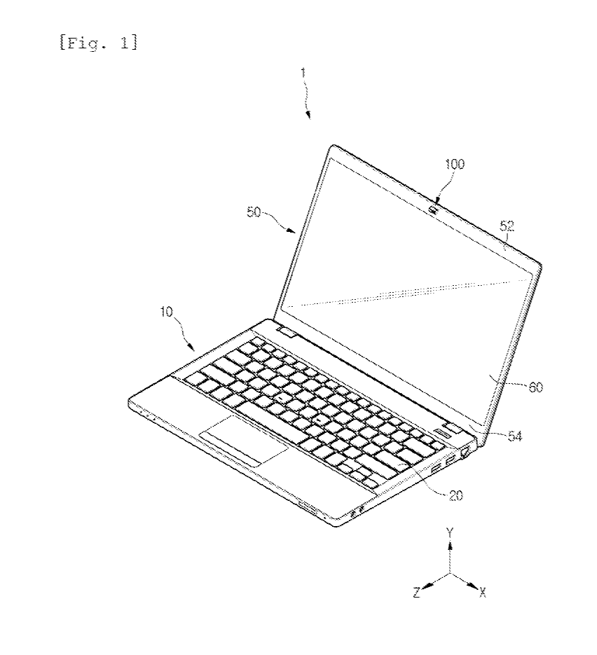

FIG. 1 is a perspective view illustrating a display apparatus according to an embodiment.

Referring to FIG. 1, a display apparatus 1 may be a portable display apparatus. For example, the display apparatus 1 may include a laptop PC or tablet PC. The laptop PC may represent a general notebook, and the tablet PC may represent a display apparatus that operates through a display touch operation by a user. In recent years, products for the laptop PC that can operate through a display touch operation to realize a tablet mode like the tablet PC have also come into the markets.

Hereinafter, in the current embodiment, the display apparatus 1 including the laptop PC (including the laptop PC in which a tablet mode can be realized) will be described as an example. The display apparatus 1 include a user manipulation unit 10, a display unit 50, and a lighting unit 100.

The user manipulation unit 10 includes various interface parts that accommodate various components for controlling an operation of the display apparatus 1 therein and are connected to an external device. The user manipulation unit 10 includes a keypad 20.

The keypad 20 controls the display unit 50 according to user's manipulation and is disposed on the user manipulation unit 10. The keypad 20 includes buttons such as charter buttons, number buttons, symbol buttons, and direction buttons. A user may push the buttons of the keypad 20 to control icons displayed on a display 60 of the display unit 50, thereby performing desired application. Since the keypad 20 is well known, its detailed description will be omitted herein.

The display unit 50 is rotatably hinge-coupled to the user manipulation unit 10. Thus, the display unit 50 may be foldably coupled to the user manipulation unit 10 so that the display apparatus 1 is easily portable when the display apparatus is not used.

The display 60 may be a part for displaying an image to the outside and be mounted on a front surface of the display unit 50. The display 60 may display various images through the keypad 20 according to the user's manipulation. In the current embodiment, a liquid crystal display may be provided as the display 60. Also, a touch panel that is capable of supporting a tablet mode may be provided as the liquid crystal display.

The lighting unit 100 emits light for illuminating the display unit 50 outwardly. The lighting unit 100 is mounted on an upper bezel 52 of the front surface of the display unit 50. The lighting unit 100 may be mounted on another portion of the display unit 50, for example, a lower bezel 54 of the front surface of the display unit 50 if light is smoothly emitted through the other portion.

The lighting unit 100 may be mounted on the display unit 50 so that the lighting unit 100 is rotatable in a vertical direction (a Y-axis direction shown in FIG. 1) and linearly movable in left and right directions or horizontal direction (an X-axis direction shown in FIG. 1) on a front portion of the display unit 50. Since the lighting unit 100 is movably mounted on the display unit 50, the direction of the light to be emitted may be changed in a horizontal direction (the X-axis direction) or the vertical direction (the Y-axis direction).

When the user uses the display apparatus 1 in a dark location, the display unit 50 for displaying an image may be visibly recognized even though the surroundings of the user is dark. However, the user may have difficulty to visually recognize the display unit 50 at a position that is not the front side of the display unit 50 on which the image is directly displayed. For example, the user may have difficulty to visually recognize symbols or numbers displayed on the buttons at the periphery of the keypad 20 of the user manipulation unit 10. The lighting unit 100 may provide illumination to the user to solve the above-described limitation. That is, as described above, the lighting unit 100 may emit light in the direction of the keypad 20 to improve user's visibility in the periphery of the keypad 20.

Furthermore, since the lighting unit 100 according to the current embodiment is movable, the emission direction of the light may be adequately changed as occasion demands.

Hereinafter, a structure of the lighting unit 100 according to the current embodiment will be described in detail.

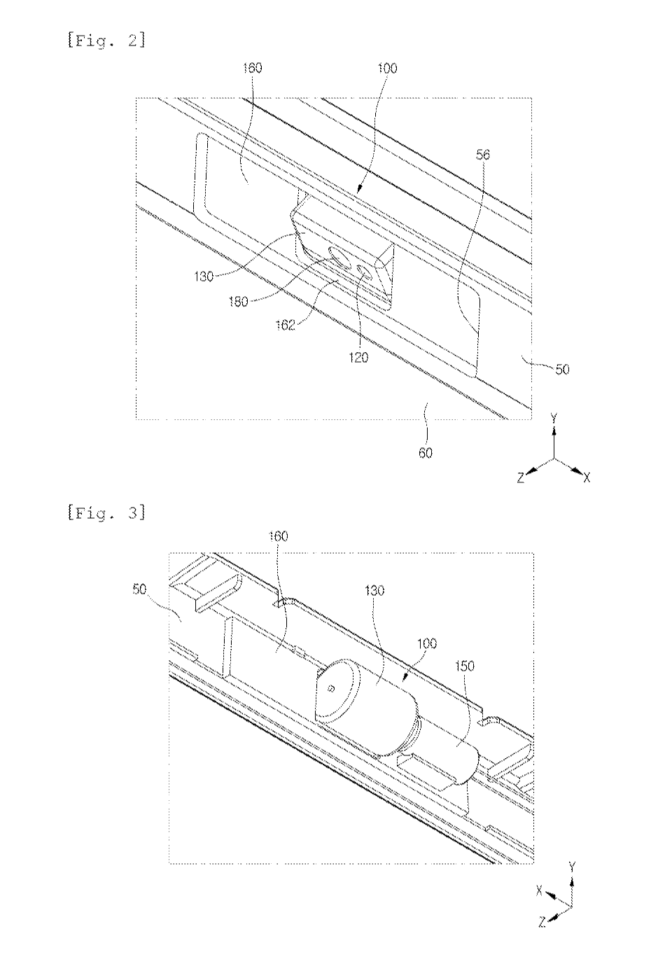

FIGS. 2 and 3 are views illustrating a lighting unit of the display apparatus of FIG. 1.

Referring to FIGS. 2 and 3, the lighting unit 100 includes a light source module 120, a lighting unit body 130, a driving motor 150, and a sliding plate 160.

The light source module 120 includes a light source for emitting light. The light source may include a light emitting diode (LED) as a light emitting body for emitting light. However, the current embodiment is not limited thereto. For example, other light emitting bodies for emitting light except for the LED may be provided as the light source.

The lighting unit body 130 is mounted on a front surface of the light source module 120. That is, the lighting unit body 130 is mounted within the display unit 50 and rotatable in the vertical direction (the Y-axis direction) with respect to the horizontal direction (the X-axis direction) of the display unit 50. A front surface of the lighting unit body 130 may protrude outward from the display unit 50 to expose front surfaces of the light source module 120 and a camera module 180 that will be described later.

The driving motor 150 may be connected to the lighting unit body 130 through a driving shaft within the display unit 50 to rotate the lighting unit body 130 in the vertical direction (the Y-axis direction). The driving motor 150 may be electrically connected to a control unit 400 to operate according to the control unit of the control unit 400. The driving motor 150 may include small DC motors or other motors, which are capable of rotating the lighting unit body 130.

The lighting unit body 130 and the driving motor 150 are mounted on a sliding plate 160. The sliding plate 160 may be linearly slidably mounted within the display unit 50 in the horizontal direction (the X-axis direction) of the display unit 50. A connection method for providing linear sliding may be realized through well-known methods using a rail or cam structure. Furthermore, the sliding plate 160, like the driving motor 150, may also be electrically connected to the control unit 400 to operate according to the control unit of the control unit 400.

A main body opening 162 for exposing the front surface of the lighting unit body 130 so that the front surfaces of the light source module 120 and the camera module 180 protrude outside the display unit 50 may be defined in the sliding plate 160. Also, a guide opening 56 for exposing a portion of the front surface of the sliding plate 160 to guide the linear movement of the light source module 120 in the horizontal direction (the X-axis direction) of the light source module 120 may be defined in the display unit 50.

As a result, when the sliding plate 160 is linearly slid in the horizontal direction (the X-axis direction), since the lighting unit body 130 is linearly slid also in the horizontal direction (the X-axis direction), the light source module 120 may also linearly move in the horizontal direction (the X-axis direction).

The camera module 180 may photograph a subject (i.e., capture an image of the subject) and be mounted on a front surface of the lighting unit body 130. The camera module 180 includes at least one lens for collecting light, an image sensor for converting an image into an electrical signal, and an actuator for moving the lens to adjust a focus of the lens.

Since the camera module 180 is mounted on the lighting unit body 130, the camera module 180 may rotate or linearly move together with the lighting unit body 130 when the lighting unit body 130 rotates in the vertical direction (the Y-axis direction) or linearly moves in the horizontal direction (the X-axis direction).

Thus, the lighting unit 100 according to the current embodiment may emit light for the illumination and also photograph the subject.

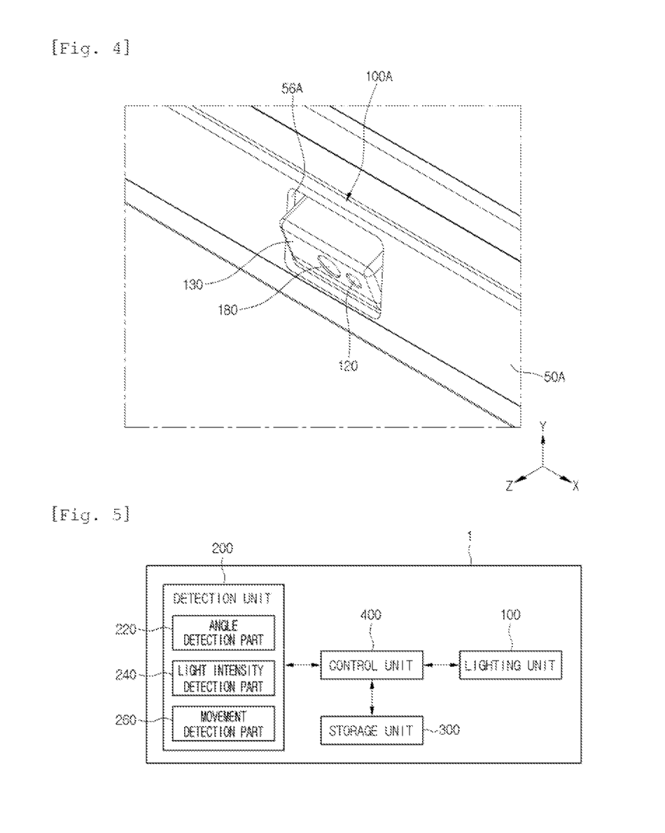

FIG. 4 is a view illustrating a lighting unit according to another embodiment.

A lighting unit 100A according to the current embodiment is similar to the lighting unit 100 according to the foregoing embodiment. Thus, duplicated descriptions with respect to the similar components will be omitted, and differences therebetween will be mainly described below.

Referring to FIG. 4, the lighting unit 100A includes a light source module 120, a lighting unit body 130, and a camera module 180.

Since the light source module 120, the lighting unit body 130, and the camera module 180 are the same as those according to the foregoing embodiment, their duplicated descriptions will be omitted.

Further, although not shown, the lighting unit 100A may include a driving motor for rotating the lighting unit body 130 in a vertical direction (a Y-axis direction), like the lighting unit 100 according to the foregoing embodiment.

The lighting unit body 130 protrudes forward from a display unit 50A through a guide opening 56A of the display unit 50A. The guide opening 56A of the display unit 50A has a horizontal width corresponding to that of the lighting unit body 130.

Unlike the lighting unit 100 according to the foregoing embodiment, the lighting unit 100A according to the current embodiment may rotate in only the vertical direction (the Y-axis direction) at a front side of the display unit 50A. That is, in the current embodiment, the lighting unit 100A may be tilted only in the vertical direction (the Y-axis direction). Thus, the lighting unit 100A may change a direction of emitted light and a photographing direction in the vertical direction (the Y-axis direction).

As described above, the lighting unit 100A may be designed to move in only one direction of the vertical direction (the Y-axis direction) or, alternatively, in the horizontal direction (the X-axis direction) according to the movement structure thereof. Also, the movement of the lighting unit 100A in the vertical direction (the Y-axis direction) may be provided by linear movement or rotational movement, as necessary.

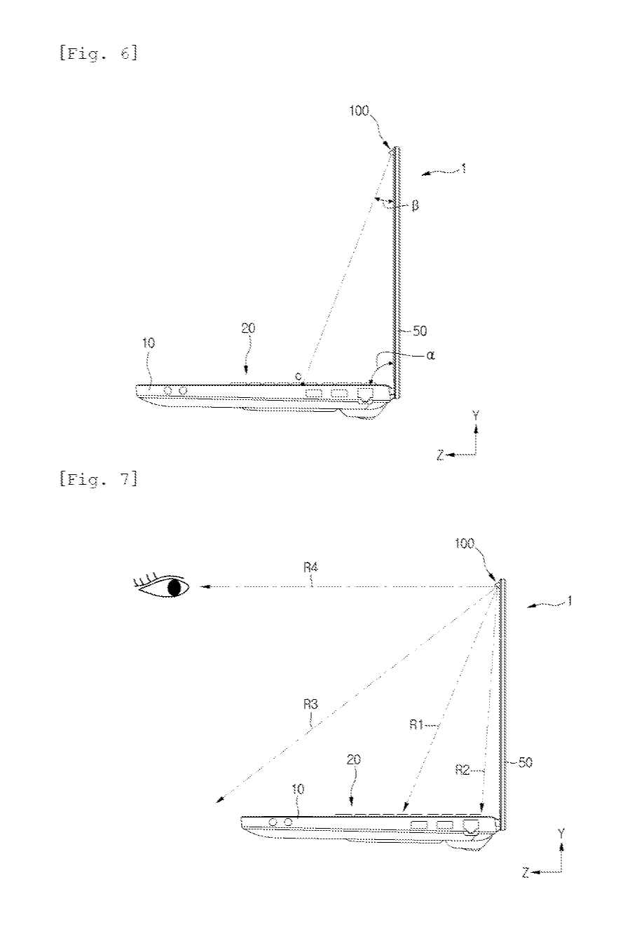

FIG. 5 is a block diagram of the display apparatus of FIG. 1.

Referring to FIG. 5, the display apparatus 1 includes the lighting unit 100, a detection unit 200, a storage unit 300, and a control unit 400.

As illustrated in FIGS. 1 to 3, the lighting unit 100 may emit light for illumination and photographing a subject. Also, the lighting unit 100 may be movably mounted on the display apparatus 1.

The detection unit 200 detects the rotation of the display apparatus 1, the light intensity of the lighting unit 100, and the movement in the periphery of the display apparatus 1. The detection unit 200 includes an angle detection part 220, a light intensity detection part 240, and a movement detection part 260.

The angle detection part 220 may detect a rotation angle of the display unit 50 hinge-coupled to the user manipulation unit 10. To achieve this, the angle detection part 220 may be provided on the hinge-coupled portion between the user manipulation unit 10 and the display unit 50. A general angle sensor for detecting a rotation angle may be provided as an angle detection part 220.

The light intensity detection part 240 may detect the Intensity of light. For this, the light intensity detection part 240 may be provided on the user manipulation unit 10 or the display unit 50. In the current embodiment, the light intensity detection part 240 disposed on the user manipulation unit 10 e.g., a bottom portion of the keypad 20) will be described as an example. A general illumination sensor for detecting the intensity of light impinging on the illumination sensor may be provided as a light intensity detection part 240.

The movement detection part 260 may detect movement in the periphery of the display apparatus 1. To achieve this, the movement detection part 260 may be provided on the user manipulation unit 10 or the display unit 50. Hereinafter, in the current embodiment, the movement detection part 260 disposed on the user manipulation unit 10 will be described as an example. A general movement detection sensor for detecting movement may be provided as a movement detection part 260.

The storage unit 300 stores various control information such as preset control information, an operating system (O/S) for operating the display apparatus 1, a firmware, an application, and control information corresponding to user interaction. The preset control information may include preset rotation angle information, preset light intensity information, preset movement information, and preset mode information. The preset mode information may include mode information with respect to a power mode in which the lighting unit 100 is turned on/off, a light intensity adjustment mode in which the intensity of light is adjusted, a keypad mode in which light is emitted toward a keypad 20, a short distance mode in which light is emitted to a side that is close to the display unit 50, a long distance mode in which light is emitted to a side that is away from the display unit 50, a lighting mode in which light for simple illumination is emitted, a photographing mode in which light for illumination when being photographed is emitted, and a video chatting mode in which light for photographing a user is emitted when video chatting is performed. Further, the storage unit 300 may include a nonvolatile memory such as a flash memory.

The control unit 400 controls the display apparatus 1 and is provided in the user manipulation unit 10 or the display unit 50 of the display apparatus 1. However, the current embodiment is not limited thereto. For example, the control unit 400 may be provided in both the user manipulation unit 10 and the display unit 50 which are electrically connected to each other.

The control unit 400 controls the overall operations of the lighting unit 100 such as the turn-on/off of the lighting unit 100, the movement of the lighting unit 100, the light intensity of the lighting unit 100, and the photographing of the camera. That is, the control unit 400 may control a power source of the lighting unit 100, control the sliding of the lighting unit 100 in the vertical or horizontal direction to move a position of the lighting unit 100, thereby changing a direction of light emitted from the lighting unit 100, controls the camera module 180 to photograph a subject, or controls the lighting unit 100 to camera illumination when the subject is photographed.

Further, the control unit 400 may control the turn-on/off of the lighting unit 100 or the movement of the lighting unit 100 on the basis of the result detected by the detection unit 200. Also, the control unit 400 may execute various operations of the lighting unit 100 on the basis of the control unit information stored in the storage unit 300.

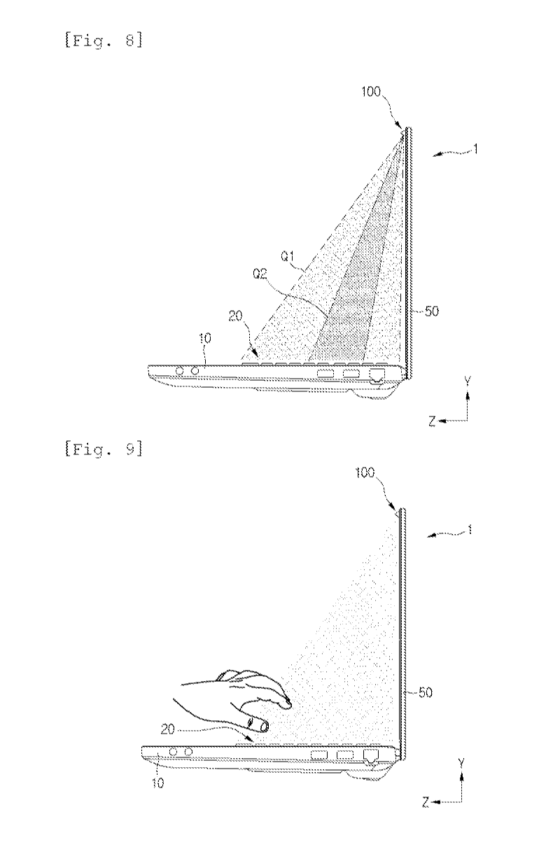

FIGS. 6 to 9 are views illustrating various control operations of the display apparatus of FIG. 1.

Referring to FIG. 6, the display apparatus 1 may emit light from the lighting unit 100 toward the keypad 20 of the user manipulation unit 10. When the display apparatus is in a dark location, the emission of light from the lighting unit 100 toward the keypad 20 may frequently occur to assist the manipulation of the keypad by the user. Thus, control information with respect to the position of the lighting unit 20 for optimally distributing light toward the keypad 20 may be previously stored in the storage unit 300. The control unit 400 may read the control unit information from the storage unit 300 to move the lighting unit 20 to a position corresponding to a preset position.

When the display apparatus 1 is a laptop PC, an angle α between the user manipulation unit 10 and the display unit 50, which are hinge-coupled to each other, may be slightly changed whenever the display apparatus 1 is used, due to characteristics of the laptop PC. In addition, the angle α between the user manipulation unit 10 and the display unit 50 may be changed by the user's manipulation. When the angle α between the user manipulation unit 10 and the display unit 50 is changed, the direction of light emitted from the lighting unit 100 may also be changed. That is, in a situation where the angle α between the user manipulation unit 10 and the display unit 50 is changed while light is being emitted from the lighting unit 100 toward the keypad 20, and if the lighting unit 100 is disposed at the same position when the display unit 50 was in the previous position, the direction the light emitted from the lighting unit 100 will be different. As a result, the distribution of the light toward the keypad 20 may move out of an optimal position, and thus, the emission direction of the light may move away from the direction of the keypad 20. In the display apparatus 1 according to the current embodiment, since the lighting unit 100 is changed in position, the position of the lighting unit 100 may be adequately adjusted to re-adjust the emission direction of the light from the lighting unit 100 to a desired position.

As described above, the adjustment in position of the lighting unit 100 may be manually operated by the user or performed by controlling the position of the lighting unit 100 through the control unit 400. If the position of the lighting unit 100 is controlled by the control unit 400, the lighting unit 100 may be more accurately adjusted in position when compared that the lighting unit 100 is manually adjusted by the user.

In detail, the control unit 400 may move the lighting unit 100 at a position at which the light is optimally distributed toward the keypad 20 according to the angle α between the user manipulation unit 10 and the display unit 50, which is detected by the angle detection part 220. To achieve this, the control unit information for optimally distributing the light toward the keypad 20 may be previously stored in the storage unit 300. For example, the storage unit 300 may previously store an optimal angle β between the display unit 50 and the lighting unit 100 that corresponding to the angle α between the user manipulation unit 10 and the display unit 50. Here, the angle β between the display unit 50 and the lighting unit 100 may represent an angle between an extension line from a center of the light emitted from the lighting unit 100 to a central position C of the keypad 20 and the display unit 50.

An optimal value in angle β between the display unit 50 and the lighting unit 100 according to the angle α between the user manipulation unit 10 and the display unit 50 is shown in Table 1 below. Control information as shown in Table 1 may be previously stored in the storage unit 300. If the angle α between the user manipulation unit 10 and the display unit 50, which is detected by the angle detection part 220, is about 75°, the control unit 400 may adjust the position of the lighting unit 100 so that the angle β between the lighting unit 100 and the display unit 50 is about 29.02° to control the lighting unit 100 so that the light is optimally emitted toward the keypad 20. The optimal value shown in Table 1 below may be illustrative and thus vary according to the dimensions of the various components of the display apparatus 1.

TABLE 1

| Angle α between user manipulation | Angle β between display |
|---|---|
| unit 10 and display unit 50 | unit 50 and lighting unit 100 |
| 75° | 29.02° |
| 80° | 28.33° |
| 85° | 27.51° |
| 90° | 26.57° |
| 95° | 25.52° |
| 100° | 24.37° |
| 105° | 23.15° |

In summary, the control unit 400 reads the angle β between the display unit 50 and the lighting unit 100 that corresponding to the detected angle α from the storage unit 300 on the basis of the angle α between the user manipulation unit 10 and the display unit 50, which is detected by the angle detection part 220. Thereafter, the control unit 400 moves the lighting unit 100 at a position at which the light is optimally distributed toward the keypad 20 according to the optimal angle β. The above-described position adjustment may be performed by rotating the lighting unit 100 in the vertical direction (the Y-axis direction). In some instances, the position adjustment may be performed together with the movement of the lighting unit 100 in the linear direction.

Referring to FIG. 7, the display apparatus 1 may variously adjust a direction of light emitted from the lighting unit 100. That is, the display apparatus 1 may emit light in a direction R1 of a center of the keypad 20 as well as other directions.

The user may desire to direct light in other directions different from the direction of the keypad 20. For example, if the user works on a separate item, such as documents or books, while in a dark location in a state where the separate item is disposed between the user manipulation unit 10 and the user, illumination may be desired to be directed more toward the separate item than the keypad 20. That is, the illumination may be desired to be directed in a long distance direction R3 in FIG. 7. In the display apparatus 1 according to the current embodiment, since the lighting unit moves in position, the lighting unit 100 may be adjusted in position so that light is emitted into the long distance direction R3.

As described above, the display apparatus 1 according to the current embodiment may adjust the position of the lighting unit 100 so that the light emitted from the lighting unit 100 is emitted in various directions as necessary.

Also, the display apparatus 1 according to the current embodiment may provide a separate preset lighting mode that is capable of providing the illumination in various preset directions. The preset lighting mode may include a short distance mode, a keypad mode, a long distance mode, and a photographing mode. The display apparatus 1 may control a light emission direction of the lighting unit 100 in a direction that matches the lighting mode selected by the user. For example, as illustrated in FIG. 7, the display apparatus 1 may adjust the position of the lighting unit 100 so that the lighting unit 100 emits light in a direction R2 that is close to the display unit 50 when the short distance mode is selected, emits light in a direction R1 of the keypad when the keypad mode is selected, emits light in a direction R3 that is away from the display unit 50 when the long distance mode is selected, and emits light in a direction R4 of the user when the photographing mode or a video chatting mode is selected.

As described above, the display apparatus 1 may control the light emission of the lighting unit 100 in a direction that matches the preset control information. To achieve this, the display apparatus 1 may store the control unit information according to the various light emission directions of the lighting unit 100 and control the position of the lighting unit 100 on the basis of the control unit information.

Referring to FIG. 8, the display apparatus 1 may adjust the intensity of the light emitted from the lighting unit 100. The display apparatus 1 may control the intensity of the light emitted from the lighting unit 100 on the basis of the intensity of light detected by the light intensity detection part 240. That is, the display apparatus 1 may control the intensity of the light emitted from the lighting unit 100 according to surrounding brightness. For example, the display apparatus 1 may increase the intensity of the light emitted from the lighting unit 100 to distribute light into a wide region Q1 (dashed) if the surroundings thereof is relatively dark. On the other hand, the display apparatus 1 may decrease the intensity of the light emitted from the lighting unit 100 to distribute light into a narrow region Q2 (dash-dot) if the surroundings thereof is relatively bright.

Thus, the display apparatus 1 according to the current embodiment may adjust the intensity of the light emitted from the lighting unit 100 on the situation to minimize power consumption due to the operation of the lighting unit 100.

The display apparatus 1 may control turn-on/off of the lighting unit 100 on the basis of the light intensity detected by the light intensity detection part 240. For example, the display apparatus 1 may turn the lighting unit 100 on if the detected light intensity is less than preset light intensity. On the other hand, the display apparatus 1 may turn the lighting unit 100 off if the detected light intensity is greater than the preset light intensity. Here, the preset light intensity may be set in consideration of the intensity of the light emitted from the display unit 50.

Since the display apparatus 1 according to the current embodiment automatically controls the operation of the lighting unit 100 according to the detected light intensity, inconvenience due to the separate user's manipulation that is required for operating the lighting unit 100 may be solved.

Referring to FIG. 9, the display apparatus 1 may detect the user's movement on the keypad 20 of the user manipulation unit 10 to control the turn-on/off of the lighting unit 100. The display apparatus 1 may control the turn-on/off of the lighting unit 100 on the basis of the movement detected by the movement detection part 260. For example, the display apparatus 1 may turn the lighting unit 100 on when the movement is detected by the movement detection part 260. On the other hand, the display apparatus 1 may turn the lighting unit 100 off when the movement is not detected for a preset time. Here, an unused condition that is preset for turning the lighting unit 100 off may be set as a critical time or a condition for detecting disappearing movement of a subject on the keypad 20 as described above.

Since the display apparatus 1 according to the current embodiment operates the lighting unit 100 through only the detected light intensity or the user's movement on the keypad 20, inconvenience duet to the user's manipulation such as separate switching for operating the lighting unit 100 may be solved.

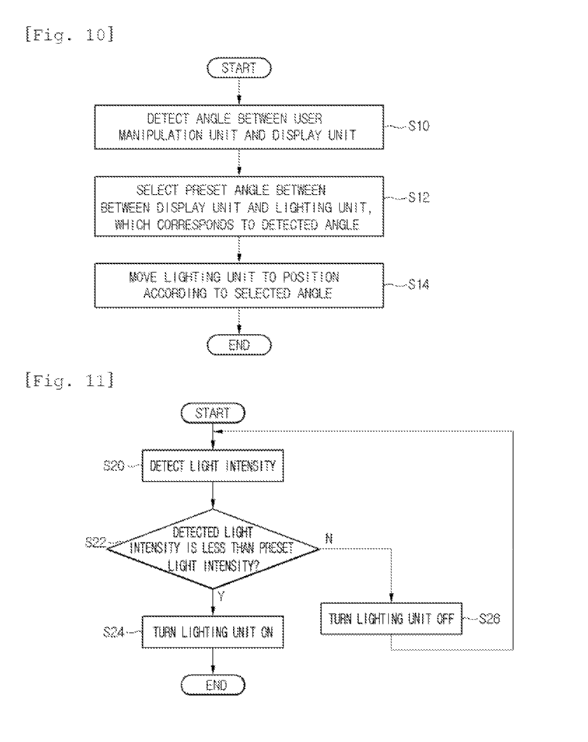

FIGS. 10 to 13 are flowcharts illustrating control methods of the display apparatus of FIG.

Since the constitutions and detection method with respect to a control method to be described with reference to FIGS. 10 to 13 are previously described, their duplicated descriptions will be omitted.

Referring to FIG. 10, a display apparatus may detect an angle between a user manipulation unit and a display unit (S10). When the angle between the user manipulation unit and the display unit is detected, the display apparatus may select a preset angle between the display unit and a lighting unit, which corresponds to the detected angle (S12). Here, the selected angle may be an angle at which light emitted from the lighting unit is distributed into a center of the keypad of the user manipulation unit. Thereafter, the display apparatus moves the lighting unit to a position according to the selected angle (S14). As described above, the display apparatus may detect the angle between the user manipulation unit and the display unit to move the lighting unit to an optimal position for illumination, which corresponds to the detected angle.

Referring to FIG. 11, the display apparatus detects a light intensity in the periphery thereof (S20) to determine whether the detected light intensity is less than a preset light intensity (S22). Thereafter, the display apparatus turns the lighting unit on when the detected light intensity is less than the preset light intensity (S24) and turns the lighting unit off when the detected light intensity is greater than the preset light intensity (S26).

As described above, the display apparatus may control the turn-on/off of the lighting unit according to the light intensity in the periphery of the display apparatus.

Referring to FIG. 12, the display apparatus detects whether a subject moves on a keypad (S30). The display apparatus turns the lighting unit on when the movement of the subject is detected (S32). If the movement of the subject is not detected, the display apparatus determines whether a preset time elapses (S34). Thereafter, the display apparatus turns the lighting unit off when the preset time elapses (S36).

As described above, the display apparatus may detect the movement of the subject to control the turn-on/off of the lighting unit.

Referring to FIG. 13, a user may execute a user mode displayed on a home screen or a wallpaper of the display apparatus or provided through a separate application (S40). Thereafter, if the user selects one of preset control information provided in the user mode (S42), the display apparatus controls an operation of the lighting unit that matches according to the selected control information (S44). Here, the preset control information may include control information with respect to a power mode in which the lighting unit is turned on/off, a light intensity adjustment mode in which the light intensity is adjusted, a keypad mode in which light is emitted toward the keypad, a short distance mode in which light is emitted to a side that is close to the display unit, a long distance mode in which light is emitted to a side that is away from the display unit, lighting mode in which light for simple illumination is emitted, a photographing mode in which light for illumination when being photographed is emitted, and a video chatting mode in which light for photographing a user is emitted when video chatting is performed.

As described above, the display apparatus may include a user interface based on user's preferences for controlling the lighting unit.

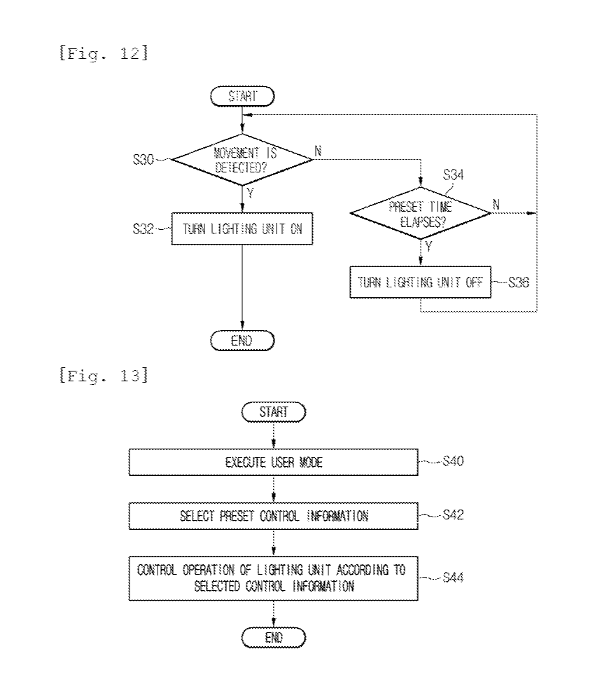

FIG. 14 is a perspective view of a display apparatus according to another embodiment.

A display apparatus according to the current embodiment is similar to the display apparatus 1 of FIG. 1. Thus, duplicated descriptions with respect to the similar components will be omitted, and differences therebetween will be mainly described below.

Referring to FIG. 14, a desktop PC may be provided as the display apparatus 2, unlike the display apparatus 1 according to the foregoing embodiment. The display apparatus 2 includes a user manipulation unit 600 and a display unit 700.

The user manipulation unit 600 and the display unit 700 are independently provided and then connected to each other in a wired or wireless manner.

The user manipulation unit 600 is disposed to be spaced a predetermined distance d from the display unit 700. The distance d between the user manipulation unit 600 and the display unit 700 may vary according to user's working environments or habits. That is, in the display apparatus 2 according to the current embodiment, the distance d between the user manipulation unit 600 and the display unit 700 may not be constantly maintained.

Like the foregoing embodiment, the user manipulation unit 600 includes a keypad 620, and the display unit 700 includes a display 750 and a lighting unit 800.

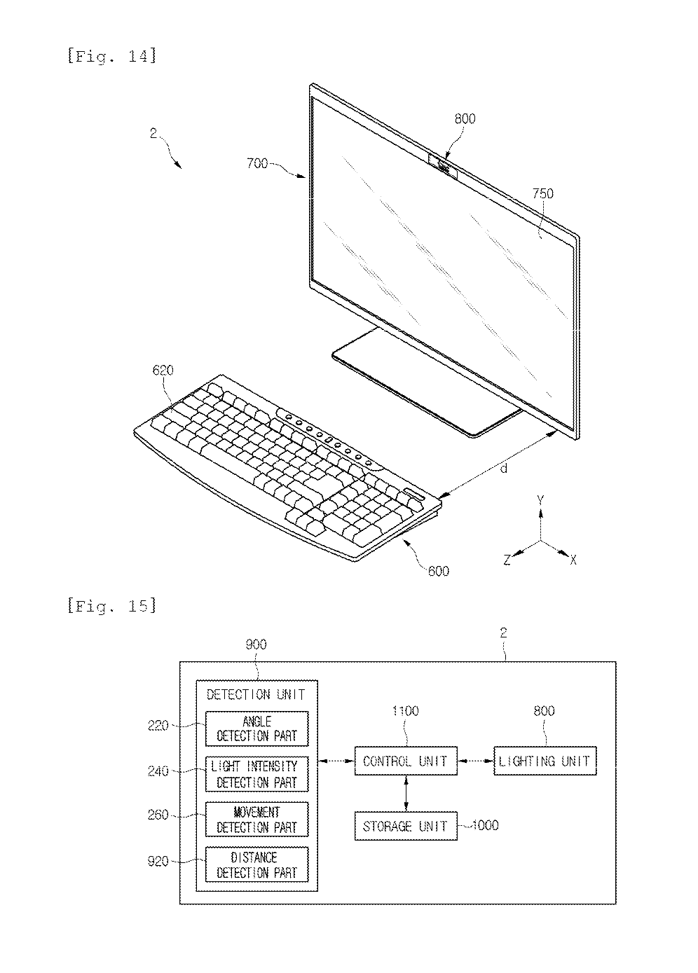

FIG. 15 is a block diagram of the display apparatus of FIG. 14.

Referring to FIG. 15, the display apparatus 2 includes a lighting unit 300, a detection unit 900, a storage unit 1000, and a control unit 1100.

Since the lighting unit 800 is substantially the same as the lighting unit 100 according to the foregoing embodiment, their duplicated descriptions will be omitted.

The detection unit 900 includes an angle detection part 220, a light intensity detection part 240, a movement detection part 260, and a distance detection part 920.

Since the angle detection part 220, the light intensity detection part 240, and the movement detection part 260 are the same as those according to the foregoing embodiment, the same reference numerals will be described, and their duplicated descriptions will be omitted.

The distance detection part 920 detects a distance between the user manipulation unit 600 and the display unit 700 and is provided in the user manipulation unit. A general distance detection sensor for detecting a distance may be provided as the distance detection part 920.

The storage unit 1000 stores control information according to preset distance information. The preset distance control information may be information with respect to an optimal position of the lighting unit 800 according to the distance between the user manipulation unit 600 and the display unit 700 or control information with respect to various user modes according to the distance between the user manipulation unit 600 and the display unit 700.

The control unit 1100 controls an operation of the lighting unit 800 on the basis of the distance information detected by the distance detection part 920. The control unit 1100 may control turn-on/off of the lighting unit 800, move the lighting unit 800 to control a direction of emitted light, or control an intensity of light emitted from the lighting unit 800 on the basis of the detected distance information.

Also, the control unit 1100 may control an operation of the lighting unit 800 according to control information that matches the detected distance information from the storage unit 1000 or execute various user modes that match the detected distance information. For example, the control unit 1100 may read the control unit information with respect to the preset optimal position of the keypad 620 which matches the distance information according to the detected distance information, from the storage unit 1000 to move the lighting unit 800 to a position corresponding to the preset position.

As described above, the display apparatus 2 according to the current embodiment may control the lighting unit 800 in consideration of the variable distance d between the user manipulation unit 600 and the display unit 700.

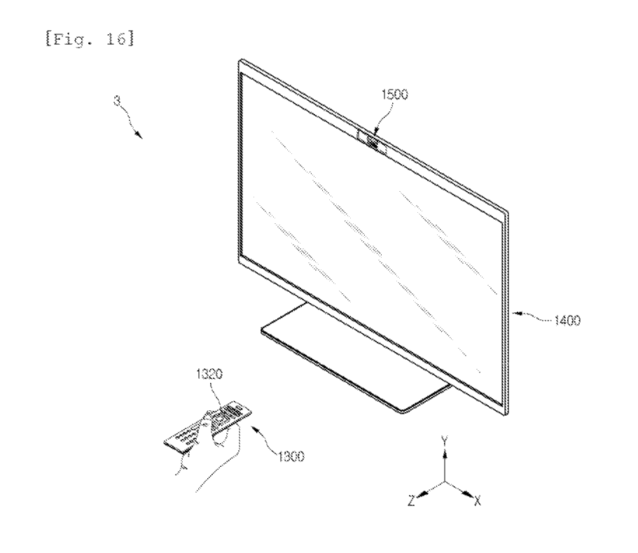

FIG. 16 is a perspective view illustrating a display apparatus according to another embodiment.

A display apparatus 3 according to the current embodiment is similar to the display apparatus 2 in FIG. 14. Thus, duplicated descriptions with respect to the similar components will be omitted, and differences therebetween will be mainly described below.

Referring to FIG. 16, a television may be provided as the display apparatus 3. The display apparatus 3 includes a user manipulation unit 1300 and a display unit 1400.

The user manipulation unit 1300 may be a remote control unit, such as a general remote controller. The user manipulation unit 1300 includes a keypad 1320 that turns a power on or off, changes a channel, or controls a volume of the television.

The user manipulation unit 1300 may remotely control the display unit 1400. The user manipulation unit 1300 may transmit/receive commands or data into/from the display unit 1400 through a wireless communication network, for example, Bluetooth, Wi-Fi, or the like, or a wireless communication network using various mobile communication standards such as 3G, LTE, or mobile WiMAX. Also, the user manipulation unit 1300 may irradiate infrared light having a predetermined frequency onto the display unit 1400 control the display unit 1400.

The display unit 1400 displays an image. In general, the display unit 1400 may be called a television. The display unit 1400 includes a lighting unit 1500.

The lighting unit 1500 is substantially the same as the lighting unit 800 in FIG. 14. Thus, the lighting unit 1500 according to the current embodiment may realize all of the constitutions and effects of the lighting unit 800 according to the foregoing embodiment.

Thus, the display apparatus 3 according to the current embodiment may realize all of the constitutions and effects of the lighting unit 800 of the display apparatus 2 according to the foregoing embodiment. As a result, the television may realize all of the above-described operations and effects through the lighting unit provided in the television, like the desktop PC.

As described above, the display apparatus according to the current embodiment may provide the display apparatus based on the user's preferences through the movable lighting unit.

According to the various embodiments, the display apparatus based on the user's preferences, which is capable of emitting light to a position desired by the user or adjusting the light intensity to desired brightness and the control unit method of the display apparatus may be provided.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display apparatus comprising:
a user manipulation unit including a keypad;
a display unit controlled by manipulating the keypad; and
a lighting unit movably mounted on the display unit, the lighting unit configured to emit light away from the display unit.

2. The display apparatus according to claim 1, further comprising a control unit, provided in at least one of the user manipulation unit and the display unit, the control unit configured to control an operation of the lighting unit.

3. The display apparatus according to claim 2, wherein the lighting unit includes a camera module configured to capture images, and
wherein the control unit is configured to control the operation of the lighting unit to allow the lighting unit to provide illumination for capturing images by the camera module.

4. The display apparatus according to claim 2, wherein the display unit is rotatably connected to the user manipulation unit,
wherein the display apparatus includes an angle detection part configured to detect a rotation angle of the display unit with respect to the user manipulation unit, and
wherein the control unit is configured to control the operation of the lighting unit based on the detected rotation angle.

5. The display apparatus according to claim 2, further comprising a light intensity detection part configured to detect intensity of the light impinging on the light intensity detection part,
wherein the control unit is configured to control an intensity of the light emitted from the lighting unit based on the detected intensity of the light impinging on the light intensity unit.

6. The display apparatus according to claim 5, wherein the control unit turns the lighting unit on when the detected light intensity is less than a preset light intensity and turns the lighting unit off when the detected light intensity is greater than the preset light intensity.

7. The display apparatus according to claim 2, further comprising a movement detection part configured to detect movement on the user manipulation unit,
wherein the control unit turns the lighting unit on when movement is detected by the movement detection part and turns the lighting unit off after a preset time when no movement is detected.

8. The display apparatus according to claim 2, further comprising a storage unit in which control information is stored,
wherein the control unit is configured to control the operation of the lighting unit according to the control information stored in the storage unit.

9. The display apparatus according to claim 8, wherein the preset control information comprises at least one of mode information with respect to a power mode in which the lighting unit is turned on/off, a light intensity adjustment mode in which the intensity of the light is adjusted, a keypad mode in which the light is emitted toward a keypad, a short distance mode in which the light is emitted to a side of the user manipulation unit that is near to the display unit, a long distance mode in which the light is emitted to a side of the user manipulation unit that is away from the display unit, a lighting mode in which the light for simple illumination is emitted, a photographing mode in which the light is emitted for capturing images, or a video chatting mode in which the light is emitted for capturing an image of the user when video chatting is performed.

10. The display apparatus according to claim 2, further comprising a distance detection part configured to detect a distance between the display unit and the user manipulation unit,
wherein the control unit is configured to control the operation of the lighting unit based on the detected distance.

11. The display apparatus according to claim 2, wherein the control unit is configured to control movement of the lighting unit such that the light emitted from the lighting unit is directed toward a center of the keypad of the user manipulation unit.

12. The display apparatus according to claim 1, wherein the lighting unit is mounted on a front side of the display unit so as to perform at least one of a vertically rotating movement or a horizontally linear movement.

13. The display apparatus according to claim 12, wherein the lighting unit comprises:
a light source module configured to generate the light;
a lighting unit body including the light source module located at a front surface thereof, the lighting unit body being located within the display unit such that the front surface of the light source module protrudes from the display unit; and
a driving motor located within the display unit to vertically rotate the lighting unit body.

14. The display apparatus according to claim 13, wherein the lighting unit further comprises a sliding plate that is mounted in the display unit to be slidable from side to side in the linear direction, the sliding plate having an opening,
wherein the lighting unit body and the driving motor are mounted on the sliding plate, and
wherein the lighting unit body extends through the opening in the sliding plate.

15. The display apparatus according to claim 14, wherein a guide opening is defined in the display unit to expose a portion of a front surface of the sliding plate.

16. The display apparatus according to claim 1, wherein the lighting unit is mounted on an upper bezel or a lower bezel of a front surface of the display unit.

17. The display apparatus according to claim 1, wherein the display apparatus is one of a television, a desktop PC, or a laptop PC.

18. A method of controlling a display apparatus having a user manipulation unit with a keypad, a display unit controlled by manipulating the keypad and a lighting unit movably mounted on the display unit, the method comprising:
detecting an angle between the display unit and the user manipulation unit;
selecting a preset angle between the display unit and the lighting unit, which corresponds to the detected angle; and
moving the lighting unit to a position corresponding to the selected angle.

19. The method according to claim 18, wherein the selected angle is an angle at which light emitted from the lighting unit is directed toward a center of the keypad of the user manipulation unit.

20. A method of controlling a display apparatus comprising a lighting unit that is movably mounted on a display unit, the method comprising:
executing a user mode;
selecting preset control information in the user mode; and
controlling an operation of the lighting unit according to the selected control information.
